(19) United States
(12) Patent Application Publication
(10) Pub. No.: US 2018/0165241 A1
(43) Pub. Date: Jun. 14, 2018

(54) CHANNEL SWITCHING DEVICE, MEMORY STORAGE DEVICE AND CHANNEL SWITCHING METHOD

(71) Applicant: PHISON ELECTRONICS CORP., Miaoli (TW)

(72) Inventors: Wei-Ting Wei, Yilan County (TW); Wei-Yung Chen, Hsinchu County (TW); Yun-Chieh Chen, Miaoli County (TW); Ta-Chuan Wei, Miaoli County (TW)

(73) Assignee: PHISON ELECTRONICS CORP., Miaoli (TW)

(21) Appl. No.: 15/429,175

(22) Filed: Feb. 10, 2017

(30) Foreign Application Priority Data
Dec. 8, 2016 (TW) 105140555

(51) Int. Cl. G06F 13/40; G06F 13/42

(52) U.S. Cl. CPC G06F 13/4022; G06F 13/4282

(57) ABSTRACT

A channel switching device, a memory storage device and a channel switching method are provided. The channel switching device includes a signal analysis module and a switch module. The signal analysis module is configured to analyze non-power signal from at least one of a plurality of connection interface units of the memory storage device. The switch module is configured to turn on a first channel coupled to a first connection interface unit among the connection interface units of the memory storage device according to an analysis result of the non-power signal, where the first channel which is turned on is for receiving first input signal from the first connection interface unit or transmitting first output signal to the first connection interface unit. Therefore, a probability of mistakenly enabling or disabling a specific connection interface unit of a memory storage device can be reduced.

### CROSS-REFERENCE TO RELATED APPLICATION

This application claims the priority benefit of Taiwan application serial no. 105140555, filed on Dec. 8, 2016. The entirety of the above-mentioned patent application is hereby incorporated by reference herein and made a part of this specification.

### BACKGROUND

### Technical Field

The present invention relates to a memory device, more particularly, to a channel switching device, memory storage device and channel switching method.

### Description of Related Art

The markets of digital cameras, cellular phones, and MP3 players have expanded rapidly in recent years, resulting in escalated demand for storage media by consumers. The characteristics of data non-volatility, low power consumption, and compact size make a rewritable non-volatile memory module (e.g., a flash memory) ideal to be built in the portable multi-media devices as cited above.

For supporting more connection interface standards by one single memory device, multiple connection interfaces are disposed on some specific memory devices. Taking the memory device having both the USB (Universal Serial Bus) 2.0 and USB 3.0 connection interfaces as an example, a user may connect the memory device to a host system (e.g., personal computer) through anyone of these two connection interfaces for operating the memory device. On the other hand, the memory device itself usually determines whether to enable or disable a specific connection interface by detecting the connection interface through which a power signal flows. However, for some memory devices capable of simultaneously connecting to multiple host systems through multiple connection interfaces, it may leading to misjudge regarding whether to enable or disable a specific connection interface by merely referencing the power signal of the connection interface.

Nothing herein should be construed as an admission of knowledge in the prior art of any portion of the present disclosure. Furthermore, citation or identification of any document in this application is not an admission that such document is available as prior art to the present disclosure, or that any reference forms a part of the common general knowledge in the art.

### SUMMARY

The present invention provides a channel switching device, a memory storage device and a channel switching method capable of reducing a probability of mistakenly enabling or disabling a specific connection interface unit of the memory storage device.

According to an exemplary embodiment of the invention, a channel switching device including a signal analysis module and a switch module is provided. The signal analysis module is coupled to a plurality of connection interface units of a memory storage device. The switch module is coupled to the signal analysis module. The signal analysis module is configured to analyze at least one non-power signal from at least one connection interface unit among the plurality of connection interface units. The switch module is configured to turn on a first channel coupled to a first connection interface unit among the connection interface units of the memory storage device according to an analysis result of the non-power signal, where the first channel is turned on for receiving first input signal from the first connection interface unit or transmitting first output signal to the first connection interface unit.

Another exemplary embodiment of the invention provides a memory storage device, which includes a plurality of connection interface units, a channel switching device, a rewritable non-volatile memory module and a memory control circuit unit. The plurality of connection interface units are configured to couple to at least one host system. The channel switching device is coupled to the plurality of connection interface units. The memory control circuit unit is coupled to the channel switching device and the rewritable non-volatile memory module. The channel switching device is configured to analyze at least one non-power signal from at least one connection interface unit among the plurality of connection interface units, and turn on a first channel coupled to a first connection interface unit among the plurality of connection interface units of the memory storage device according to an analysis result of the at least one non-power signal, where the memory control circuit unit is configured to receive a first input signal from the first connection interface unit or transmit a first output signal to the first connection interface unit through the first channel which is turned on.

Another exemplary embodiment of the invention provides a channel switching method adapted to a memory storage device having a plurality of connection interface units, the channel switching method includes: analyzing at least one non-power signal from at least one connection interface unit among a plurality of connection interface units; turning on a first channel coupled to a first connection interface unit among the plurality of connection interface units of the memory storage device according to an analysis result of the at least one non-power signal; and receiving a first input signal from the first connection interface unit or transmitting a first output signal to the first connection interface unit through the first channel which is turned on.

Based on the above, the signal analysis module may analyze the signal from at least one connection interface unit of the memory storage device, and the analyzed signal at least includes a non-power signal. According to an analysis result, the switch module may turn on a first channel coupled to a first connection interface unit of the memory storage device, to receive a first input signal from the first connection interface unit or transmit a first output signal to the first connection interface unit through the first channel which is turned on. Therefore, a probability of mistakenly enabling or disabling a specific connection interface unit of a memory storage device can be reduced.

To make the above features and advantages of the invention more comprehensible, several embodiments accompanied with drawings are described in detail as follows.

It should be understood, however, that this Summary may not contain all of the aspects and embodiments of the present invention, is not meant to be limiting or restrictive in any manner, and that the invention as disclosed herein is and will be understood by those of ordinary skill in the art to encompass obvious improvements and modifications thereto.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a host system, a memory storage device and an I/O (input/output) device according to an exemplary embodiment of the invention.

FIG. 2 is a schematic diagram illustrating a host system, a memory storage device and an I/O device according to another exemplary embodiment of the invention.

FIG. 3 is a schematic diagram illustrating a host system and a memory storage device according to another exemplary embodiment of the invention.

FIG. 4 is a schematic block diagram illustrating a memory storage device according to an exemplary embodiment of the invention.

FIG. 5 is a schematic diagram illustrating a channel switching device according to an exemplary embodiment of the invention.

FIG. 6 is a schematic diagram illustrating a channel switching device according to another exemplary embodiment of the invention.

FIG. 7 is a flowchart illustrating a channel switching method according to an exemplary embodiment of the invention.

### DESCRIPTION OF THE EMBODIMENTS

Multiple exemplary embodiments are provided below for describe the present invention, but the present invention is not limited thereto. Appropriate combinations of the exemplary embodiments are allowed as well. A term “couple” used in the full text of the disclosure (including the claims) refers to any direct and indirect connections. For example, if a first device is described to be coupled to a second device, it is interpreted as that the first device is directly coupled to the second device, or the first device is indirectly coupled to the second device through other devices or connection means. Moreover, a term “signal” refers to at least one of current, voltage, charge, temperature, data, or any other one or more signals.

Reference will now be made in detail to the present preferred embodiments of the disclosure, examples of which are illustrated in the accompanying drawings. Wherever possible, the same reference numbers are used in the drawings and the description to refer to the same or like parts.

Embodiments of the present disclosure may comprise any one or more of the novel features described herein, including in the Detailed Description, and/or shown in the drawings. As used herein, “at least one”, “one or more”, and “and/or” are open-ended expressions that are both conjunctive and disjunctive in operation. For example, each of the expressions “at least on of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

It is to be noted that the term “a” or “an” entity refers to one or more of that entity. As such, the terms “a” (or “an”), “one or more” and “at least one” can be used interchangeably herein.

Generally, the memory storage device (also known as a memory storage system) includes a rewritable non-volatile memory module and a controller (also known as a control circuit). The memory storage device is usually configured together with a host system so that the host system may write data into the memory storage device or read data from the memory storage device.

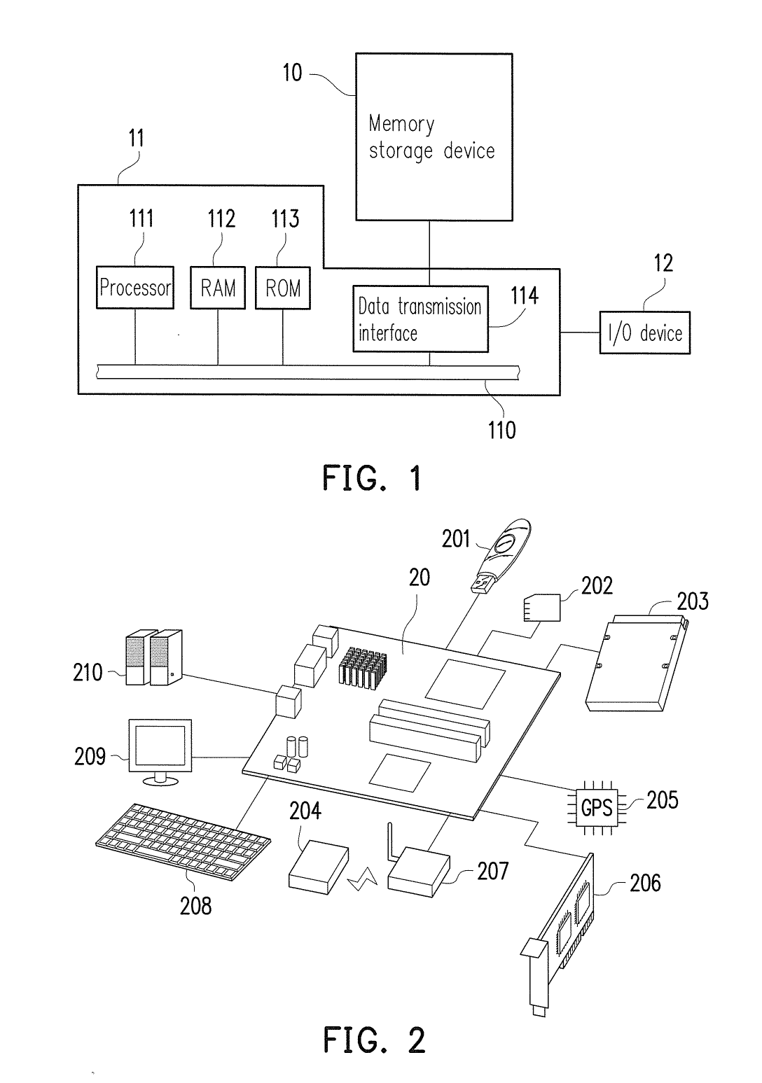

FIG. 1 is a schematic diagram illustrating a host system, a memory storage device and an I/O (input/output) device according to an exemplary embodiment of the invention. FIG. 2 is a schematic diagram illustrating a host system, a memory storage device and an I/O device according to another exemplary embodiment of the invention.

Referring to FIG. 1 and FIG. 2, a host system 11 generally includes a processor 111, a RAM (random access memory) 112, a ROM (read only memory) 113 and a data transmission interface 114. The processor 111, the RAM 112, the ROM 113 and the data transmission interface 114 are coupled to a system bus 110.

In the present exemplary embodiment, the host system 11 is coupled to a memory storage device 10 through the data transmission interface 114. For example, the host system 11 can store data into the memory storage device 10 or read data from the memory storage device 10 through the data transmission interface 114. Further, the host system 11 is coupled to an I/O device 12 through the system bus 110. For example, the host system 11 can transmit output signals to the I/O device 12 or receive input signals from I/O device 12 through the system bus 110.

In the present exemplary embodiment, the processor 111, the RAM 112, the ROM 113 and the data transmission interface 114 may be disposed on a main board 20 of the host system 11. The number of the data transmission interface 114 may be one or more. Through the data transmission interface 114, the main board 20 may be coupled to the memory storage device 10 in a wired manner or a wireless manner. The memory storage device 10 may be, for example, a flash drive 201, a memory card 202, a SSD (Solid State Drive) 203 or a wireless memory storage device 204. The wireless memory storage device 204 may be, for example, a memory storage device based on various wireless communication technologies, such as a NFC (Near Field Communication) memory storage device, a WiFi (Wireless Fidelity) memory storage device, a Bluetooth memory storage device, a Bluetooth low energy memory storage device (e.g., iBeacon). Further, the main board 20 may also be coupled to various I/O devices including a GPS (Global Positioning System) module 205, a network interface card 206, a wireless transmission device 207, a keyboard 208, a monitor 209 and a speaker 210 through the system bus 110. For example, in an exemplary embodiment, the main board 20 may access the wireless memory storage device 204 through the wireless transmission device 207.

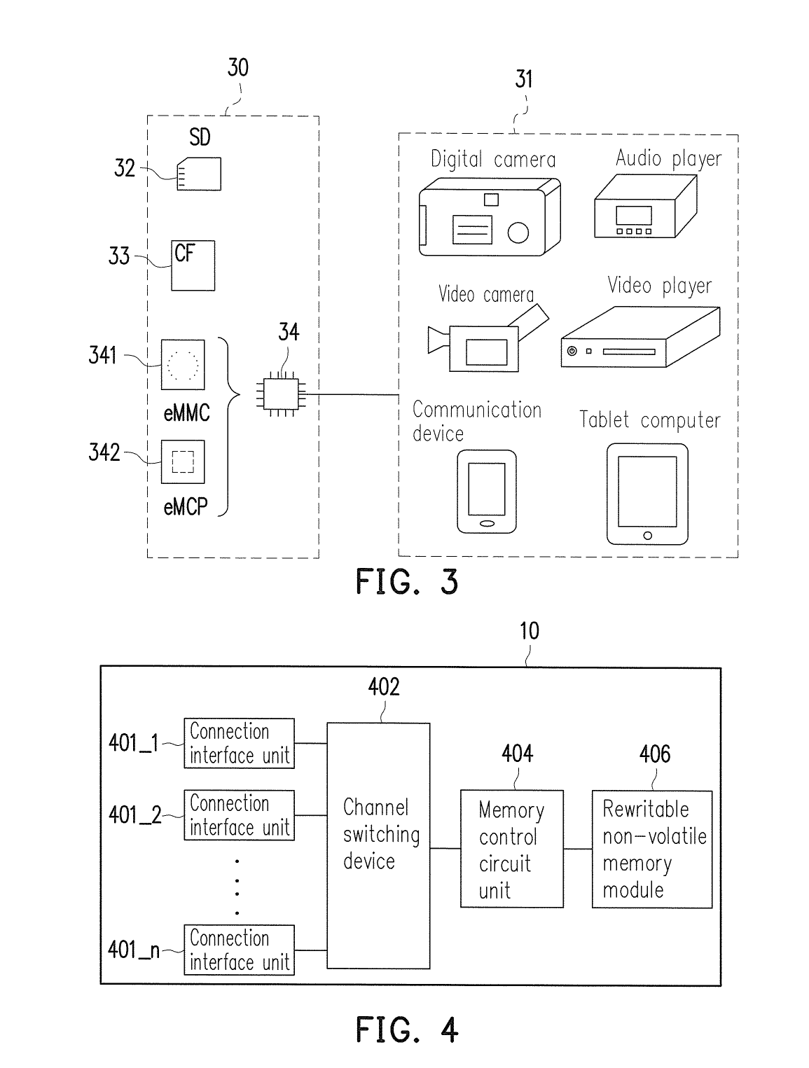

In exemplary embodiment, aforementioned host system may be any system capable of substantially cooperating with the memory storage device for storing data. The host system is illustrated as a computer system in foregoing exemplary embodiment; nonetheless, FIG. 3 is a schematic diagram illustrating a host system and a memory storage device according to another exemplary embodiment of the invention. Referring to FIG. 3, a host system 31 may also be a system including a digital camera, a video camera, a communication device, an audio player, a video player or a tablet computer, whereas a memory storage device 30 may be various non-volatile memory devices used by the host system 31, such as a SD (Secure Digital) card 32, a CF (Compact Flash) card 33 or an embedded storage device 34. The embedded storage device 34 includes various embedded storage devices capable of directly coupling a memory module onto a substrate of the host system 31, such as an eMMC (embedded Multi Media Card) 341 and/or an eMCP (embedded Multi Chip Package) storage device 342.

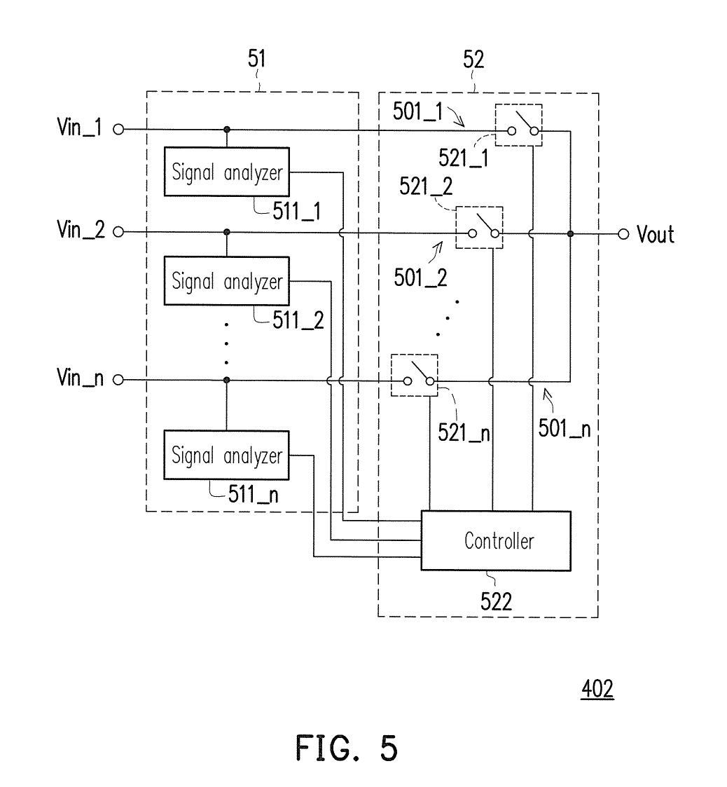

FIG. 4 is a schematic block diagram illustrating a memory storage device according to an exemplary embodiment of the invention.

Referring to FIG. 4, the memory storage device 10 includes a plurality of connection interface units 401_1 to 401_n, a channel switching device 402, a memory control circuit unit 404 and a rewritable non-volatile memory module 406.

Each of the connection interface units 401_1 to 401_n is configured to couple the memory storage device 10 to a host system. If at least two of the connection interface units 401_1 to 401_n are respectively coupled to one host system, the types of the host systems being coupled may be the same or different from each other. In the present exemplary embodiment, a total number of the connection interface units 401_1 to 401_n is 2 (i.e., n is 2). In another exemplary embodiment, a total number of the connection interface units 401_1 to 401_n may be larger than 2 (i.e., n is an integer larger than 2).

In the present exemplary embodiment, each of the connection interface units 401_1 to 401_n may be compatible to a SATA (Serial Advanced Technology Attachment) standard, a PATA (Parallel Advanced Technology Attachment) standard, an IEEE (Institute of Electrical and Electronic Engineers) 1394 standard, a PCI Express (Peripheral Component Interconnect Express) interface standard, a USB (Universal Serial Bus) standard, a SD interface standard, a UHS-I (Ultra High Speed-I) interface standard, a UHS-II (Ultra High Speed-II) interface standard, a MS (Memory Stick) interface standard, a MCP interface standard, a MMC interface standard, an eMMC interface standard, a UFS (Universal Flash Storage) interface standard, an eMCP interface standard, a CF interface standard, an IDE (Integrated Device Electronics) interface standard or other suitable standard.

The channel switching device 402 is coupled to the connection interface units 401_1 to 401_n and the memory control circuit unit 404. The channel switching device 402 is configured to analyze the signal from at least one connection interface unit among the connection interface units 401_1 to 401_n, and turn on a specific channel coupled to a specific connection interface unit among the connection interface units 401_1 to 401_n of the memory storage device 10 according to an analysis result. Then, the memory control circuit unit 404 may receive an input signal from the specific connection interface unit or transmit an output signal to the specific connection interface unit through the specific channel which is turned on.

Generally, the signal from the connection interface units 401_1 to 401_n probably include power signal and non-power signal. In an exemplary embodiment, the power signal refers to the power transmitted on at least one of the connection interface units 401_1 to 401_n. For example, the power signal may be the power provided to the memory storage device 10 by the host system coupled to one of the connection interface units 401_1 to 401_n. For example, the power may be transmitted through the V_{BUS} pin of the connection interface unit. Alternatively, in one exemplary embodiment, the power signal may also refer to a signal with a power information transmitted through at least one of the connection interface units 401_1 to 401_n. For example, the power signal may be provided by the host system and carry information (i.e., power information) related to the power specification of the host system. For example, the power information may be transmitted through the CC (configuration channel) pin of the connection interface unit compatible to USB 3.0 type-c, or through pin(s) having similar functions of other types of connection interface units. Besides, the non-power signal refers to at least one type of signal which is not belonging to the power signal. For example, in one exemplary embodiment, the non-power signal refers to the signal capable for identifying a specific connection interface unit being about to transmit (or being transmitting) data signals.

It is noted that, the signals analyzed by the channel switching device 402 include at least the non-power signal. For example, in one exemplary embodiment, the channel switching device 402 may (only) analyze the non-power signal from at least one of the connection interface units 401_1 to 401_n to generate the analysis result. Alternatively, in another exemplary embodiment, the channel switching device 402 may analyze the power signal and the non-power signal from the same or different connection interface units among the connection interface units 401_1 to 401_n to generate the analysis result.

In one exemplary embodiment, the connection interface units 401_1 to 401_n and the channel switching device 402 may be assembled in one chip with the memory control circuit unit 404. Alternatively, in another exemplary embodiment, the connection interface units 401_1 to 401_n and/or the channel switching device 402 may be disposed outside the chip including the memory control circuit unit 404.

The memory control circuit unit 404 (also referred to as memory controller) is configured to execute a plurality of logic gates or control commands which are implemented in a hardware form or in a firmware form and perform operations, such as writing, reading or erasing data in the rewritable non-volatile memory module 406 according to the commands of the host system 11.

The rewritable non-volatile memory module 406 is coupled to the memory control circuit unit 404 and configured to store data written by the host system 11. The rewritable non-volatile memory module 406 may be a SLC (Single Level Cell) NAND flash memory module (i.e., a flash memory module capable of storing one bit in one memory cell), a MLC (Multi Level Cell) NAND flash memory module (i.e., a flash memory module capable of storing two bits in one memory cell), a TLC (Triple Level Cell) NAND flash memory module (i.e., a flash memory module capable of storing three bits in one memory cell), other flash memory modules or any memory module having the same features.

Each of the memory cells in the rewritable non-volatile memory module 406 stores one or more bits based on a voltage (hereinafter, also known as a threshold voltage) change. More specifically, in each of the memory cells, a charge trapping layer is provided between a control gate and a channel. Amount of electrons in the charge trapping layer may be changed by applying a write voltage to the control gate thereby changing the threshold voltage of the memory cell. This process of changing the threshold voltage of a memory cell is also known as “writing data into the memory cell” or “programming the memory cell”. With changes in the threshold voltage, each of the memory cells in the rewritable non-volatile memory module 406 has a plurality of storage states. The storage state to which the memory cell belongs may be determined by applying a read voltage, so as to obtain the one or more bits stored in the memory cell.

In the present exemplary embodiment, the memory cells of the rewritable non-volatile memory module 406 constitute a plurality of physical programming units, and the physical programming units constitute a plurality of physical erasing units. Specifically, the memory cells on the same word line constitute one or more of the physical programming units. If each of the memory cells can store two or more than two bits, the physical programming units on the same word line can be at least classified into a lower physical programming unit and an upper physical programming unit. For example, a LSB (Least Significant Bit) of one memory cell belongs to the lower physical programming unit, and a MSB (most significant bit) of one memory cell belongs to the upper physical programming unit. Generally, in the MLC NAND flash memory, a writing speed of the lower physical programming unit is higher than a writing speed of the upper physical programming unit, and/or a reliability of the lower physical programming unit is higher than a reliability of the upper physical programming unit.

In the present exemplary embodiment, the physical programming unit is a minimum unit for programming. That is, the physical programming unit is the minimum unit for writing data. For example, the physical programming unit is a physical page or a physical sector. If the physical programming unit is the physical page, the physical programming unit usually include a data bit area and a redundancy bit area. The data bit area includes multiple physical sectors configured to store user data, and the redundant bit area is configured to store system data (e.g., management data such as an error correcting code). In the present exemplary embodiment, the data bit area contains 32 physical sectors, and a size of each physical sector is 512 bytes (B). However, in other exemplary embodiments, the data bit area may also include 8, 16 physical sectors or different number (more or less) of the physical sectors, and the size of each physical sector may also be greater or smaller. On the other hand, the physical erasing unit is the minimal unit for erasing. Namely, each physical erasing unit contains the least number of memory cells to be erased together. For instance, the physical erasing unit is a physical block.

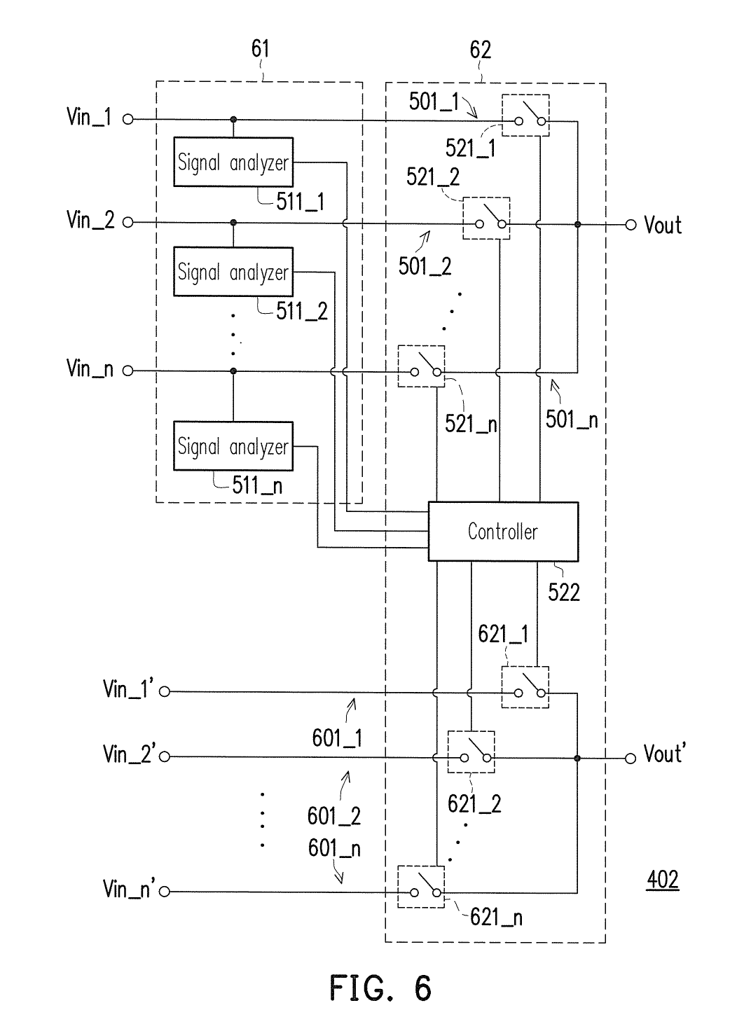

FIG. 5 is a schematic diagram illustrating a channel switching device according to an exemplary embodiment of the invention.

Please refer to FIG. 5, in one exemplary embodiment, the channel switching device 402 includes a signal analysis module 51 and a switch module 52. The signal analysis module 51 is coupled to the switch module 52. The signal analysis module 51 includes a plurality of signal analyzers 511_1 to 511_n. The signal analyzer 511_i is coupled to an endpoint Vin_i, and the endpoint Vin_i is coupled to the connection interface unit 401_i, where 0<i<(n+1) and i is an integer. In addition, the signal analyzer 511_i may be configured to actively detect and analyze the signal from the connection interface unit 401_i through the endpoint Vin_i.

It is noted that, the exemplary embodiment of FIG. 5 uses the separate signal analyzers 511_1 to 511_n as the example of signal analysis module 51, however, in another exemplary embodiment, at least two of the signal analyzers 511_1 to 511_n may be combined into one signal analyzer, which is not limited in the present invention.

In one exemplary embodiment, the endpoint Vin_i is coupled to the data pin of the connection interface unit 401_i, and the signal analyzer 511_i is at least configured to analyze the signal transmitted through the data pin of the connection interface unit 401_i. Generally, the respective data pin of the connection interface unit 401_1 to 401_n are mainly configured to transmit data signal including the data to be transmitted. However, the data pin of at least one of the connection interface units 401_1 to 401_n may also transmit other types of signal (e.g., idle signal) in some cases. In one exemplary embodiment, the data pin may not be configured to transmit said power signal. In one exemplary embodiment, at least one (or all) signal transmitted through the aforementioned data pin may be referred to as the non-power signal. In addition, in one exemplary embodiment, the data pin may be also referred to as the I/O (input/output) pin.

In one exemplary embodiment, if a connection interface unit is compatible to USB 2.0 type-a or type-b, the data pin of the connection interface unit may refer to as the D+ pin or the D− pin. In one exemplary embodiment, if a connection interface unit is compatible to USB 3.0 type-a or type-b, the data pin of the connection interface unit may refer to as the D+ pin, the D− pin, the SSRX+ pin or the SSRX− pin. Alternatively, in one exemplary embodiment, if a connection interface unit is compatible to USB 3.0 type-c, the data pin of the connection interface unit may refer to as the SSRXn2 pin, the SSRXp2 pin, the Dp1 pin, the Dn1 pin, the SSRXn1 pin, the SSRXp1 pin, the Dp2 pin or the Dn2 pin. In other exemplary embodiments not being mentioned, pins of other types of connection interface units which are mainly used for transmitting data signal may be referred to as the data pin, which is not repeated herein.

Referring back to FIG. 5, the switch module 52 includes a plurality of switch units 521_1 to 521_n and a controller 522. One end of the switch unit 521_i is coupled to the endpoint Vin_i, and another end of the switch unit 521_i is coupled to an endpoint Vout, where 0<i<(n+1) and i is an integer. The endpoint Vout is coupled to the memory control circuit unit 404. The controller 522 may receive an analysis result of at least one of the signal analyzers 511_1 to 511_n, and control the switch units 521_1 to 521_n according to the analysis result. Specifically, the controller 522 may control the switch unit 521_i to turn on the channel 501_i, so that the signal may be transmitted between the endpoint Vin_i and the endpoint Vout through the channel 501_i. Alternatively, the controller 522 may control the switch unit 521_i to cut off the channel 501_i, so as to prevent the signal from being transmitted between the endpoint Vin_i and the endpoint Vout. For convenience of illustration, n=2 is taken as an example for illustrating the channel switching device 402.

In the exemplary embodiment that n=2, the signal analysis module 51 includes a signal analyzer (also referred to as a first signal analyzer) 511_1 and a signal analyzer (also referred to as a second signal analyzer) 511_2. The endpoint Vin_1 is coupled to the connection interface unit (also referred to as a first connection interface unit) 401_1. The endpoint Vin_2 is coupled to the connection interface unit (also referred to as a second connection interface unit) 401_2. The connection interface unit 401_1 is compatible to a connection interface standard (also referred to as a first connection interface standard). The connection interface unit 401_2 is compatible to another connection interface standard (also referred to as a second connection interface standard). The first connection interface standard is different from the second connection interface standard. For example, in one exemplary embodiment, the first connection interface standard is USB 2.0 type-a, and the second connection interface standard is USB 3.0 type-c. However, in another exemplary embodiment, the first connection interface standard and the second connection interface standard may be other types of connection interface standard, and/or the first connection interface standard and the second connection interface standard may be compatible to the same connection interface standard, which is not limited in the present invention.

The signal analyzer 511_1 is coupled to the endpoint Vin_1 and configured to analyze the signal from the connection interface unit 401_1. The signal analyzer 511_2 is coupled to the endpoint Vin_2 and configured to analyze the signal from the connection interface unit 401_2. More specifically, the signal analyzer 511_1 may analyze the signal of the endpoint Vin_1 for detecting a specific signal (also referred to as a first signal) which complies with an active condition (also referred to as a first activate condition) corresponding to the connection interface unit 401_1. On the other hands, the signal analyzer 511_2 may analyze the signal of the endpoint Vin_2 for detecting another specific signal (also referred to as a second signal) which complies with another active condition (also referred to as a second activate condition) corresponding to the connection interface unit 401_2. It is noted that, the first signal complies with the first activate condition means that a signal state of the first signal (also referred to as a first signal state) complies with the first active condition, and the second signal complies with the second activate condition means that a signal state of the second signal (also referred to as a second signal state) complies with the second active condition. For example, the signal state may refer to the voltage level, pulse waveform and/or frequency.

If the analysis result of the signal analyzers 511_1 and 511_2 shows that the first signal state of the first signal from connection interface unit 401_1 complies with the first activate condition, and the second signal complying with the second activate condition (also referred to as the second signal corresponding to the second active condition) from the connection interface unit 401_2 does not exist (i.e., not being detected), the controller 522 may control the switch unit 521_1 to turn on the channel 501_1 and control the switch unit 521_2 to cut off the channel 501_2 according to the analysis result. In the present exemplary embodiment, the channel 501_1 is also referred to as a first channel which is a signal path between the endpoints Vin_1 and Vout, and the channel 501_2 is also referred to as a second channel which is a signal path between the endpoints Vin_2 and Vout. In other words, after the channel 501_1 is turned on, the channel 501_1 is in a turned-on state and the channel 501_2 is in a cut-off state. In addition, in another exemplary embodiment that n is larger than two, if the channel 501_1 is in the turned-on state, the other channels 501_2 to 501_n are in the cut-off state.

After the channel 501_1 is turned on, the signal from the connection interface unit 401_1 (also referred to as a first input signal) may be transmitted to the memory control circuit unit 404 through the channel 501_1, or the signal from the memory control circuit unit 404 (also referred to as a first output signal) may be transmitted to the connection interface unit 401_1 through the channel 501_1. For example, according to the first input signal, the memory control circuit unit 404 may instruct the rewritable non-volatile memory module 406 to perform a corresponding write, read or erase operation. Alternatively, the memory control circuit unit 404 may transmit the data read from the rewritable non-volatile memory module 406 to the connection interface unit 401_1 by the first output signal.

In one exemplary embodiment, before the channel 501_1 is turned on, the analysis result of the signal analyzers 511_1 and 511_2 shows that the second signal state of the second signal from the connection interface unit 401_2 complies with the second activate condition (i.e., the second signal corresponding to the second active condition is detected), and the first signal complying with the first activate condition from the connection interface unit 401_1 does not exist (i.e., the first signal corresponding to the first active condition is not detected). According to the analysis result, the controller 522 may control the switch unit 521_1 to cut off the channel 501_1 and control the switch unit 521_2 to turn on the channel 501_2. In other words, before the channel 501_1 is turned on, the channel 501_1 is in a cut-off state and the channel 501_2 is in a turned-on state. In such state, the signal from the connection interface unit 401_2 (also referred to as a second input signal) may be transmitted to the memory control circuit unit 404 through the channel 501_2, or the signal from the memory control circuit unit 404 (also referred to as a second output signal) may be transmitted to the connection interface unit 401_2 through the channel 501_2. In addition, in another exemplary embodiment that n is larger than two, if the channel 501_2 is in the cut-off state, the other channels 501_1, and 501_3 to 501_n are in the turned-on state.

It is noted that, the aforementioned exemplary embodiment, which channel of the channels 501_1 and 501_2 (or more channels) to be turned on is determined according to the analysis result of the signal analyzers 511_1 and 511_2 (or more signal analyzers) simultaneously, however, in another exemplary embodiment, the switch module 52 may turn on a specific channel according to the analysis result of signal of a specific endpoint among the endpoints Vin_1 to Vin_n, without obtaining all analysis results of the signals of all of the endpoints Vin_1 to Vin_n. For example, in one exemplary embodiment, if the analysis result of the signal analyzer 511_1 shows that the first signal state of the first signal from the connection interface unit 401_1 complies with the first activate condition, even the analysis results of the signal analyzers 511_2 to 511_n are not obtained at this moment, the controller 522 may control the switch unit 521_1 to turn on the channel 501_1 and control the rest switch units 521_2 to 521_n to cut off the channels 501_2 to 501_n. Therefore, a switching efficiency of the channels can be improved.

Generally, if a host system coupled to a specific connection interface unit among the connection interface units 401_1 to 401_n is for accessing the memory storage device 10 (e.g., reading data from the memory storage device 10 or storing data into the memory storage device 10), the signal from the host system may comply with a specific condition corresponding to the specific connection interface unit. Taking the connection interface unit 401_1 as an example, if a host system (also referred to as a first host system) coupled to the connection interface unit 401_1 is for accessing the memory storage device 10, the first host system may send a specific signal in a handshaking operation with the memory storage device 10, and the voltage level of the specific signal may exceed a preset voltage level (also referred to as a first preset voltage level) corresponding to the connection interface unit 401_1. Therefore, in one exemplary embodiment, the signal analyzer 511_1 may determine whether a signal having a voltage level which exceeds the first preset voltage level is detected. If a signal having the voltage level which exceeds the first preset voltage level is detected, the detection result of the signal analyzer 511_1 may show that the first signal complying with the first activate condition is detected.

After the connection between the first host system and the memory storage device 10 is established, the first host system may transmit data in a form of data signal to the memory storage device 10. Therefore, in one exemplary embodiment, the signal analyzer 511_1 may also determine whether a data signal (also referred to as a first data signal) is detected. If the first data signal is detected, the detection result of the signal analyzer 511_1 may show that the first signal complying with the first activate condition is detected.

During a period that the connection between the first host system and the memory storage device 10 is established and the data signal is not yet transmitted to the memory storage device 10, the first host system may send an idle signal to the memory storage device 10. The idle signal is configured to maintain the connection between the first host system and the memory storage device 10 in a preset time range. Therefore, in one exemplary embodiment, the signal analyzer 511_1 may also determine whether an idle signal (also referred to as a first idle signal) is detected. If the first idle signal is detected, the detection result of the signal analyzer 511_1 may show that the first signal complying with the first activate condition is detected.

The operation of determining whether the first signal complying with the first activate condition is detected may be also applied to other signal analyzers 511_2 to 511_n. It is noted that, in one exemplary embodiment, the connection interface units 401_1 to 401_n are compatible to different connection interface standards, therefore the signal state (e.g., voltage level, pulse waveform and/or frequency) of various signals transmitted through the connection interface unit 401_1 to 401_n may be different as well. Correspondingly, the determination conditions used for determining whether the signal complying with a specific activate condition is detected on different connection interface units may also be different. For example, in one exemplary embodiment, the first connection interface standard compatible to the connection interface unit 401_1 is different from the second connection interface standard compatible to the connection interface unit 401_2, therefore the second activate condition used by the signal analyzer 511_2 is different from the first activate condition used by the signal analyzer 511_1. For example, in the operation of analyzing the signal from the connection interface unit 401_2, the signal analyzer 511_2 may determine whether a signal having a voltage level which exceeds another preset voltage level (also referred to as a second preset voltage level) is detected, determine whether a second data signal is detected, or determine whether a second idle signal is detected. In such exemplary embodiment, the second preset voltage level may be different from the first preset voltage level, the signal state (e.g., voltage level, pulse waveform and/or frequency) of the second data signal may be different from the signal state of the first data signal, and the signal state of the second idle signal may be different from the signal state of the first idle signal.

It is noted that, in the exemplary embodiment of FIG. 5, the channel 501_i refers to a channel (also referred to as a receive channel) for transmitting signal from the endpoint Vin_i to the endpoint Vout, or a channel (also referred to as a transmit channel) for transmitting signal from the endpoint Vout to the endpoint Vin_i. In another exemplary embodiment, the channel switching device 402 may turn on the receive channel and the transmit channel connected to the same connection interface unit among the connection interface units 401_1 to 401_n simultaneously.

FIG. 6 is a schematic diagram illustrating a channel switching device according to another exemplary embodiment of the invention.

Please refer to FIG. 6, in one exemplary embodiment, the channel switching device 402 includes a signal analysis module 61 and a switch module 62. The signal analysis module 61 is coupled to the switch module 62. The signal analysis module 61 includes a plurality of signal analyzers 511_1 to 511_n. The switch module 62 includes a plurality of switch units 521_1 to 521_n and a controller 522. The descriptions regarding the signal analyzers 511_1 to 511_n, switch unit 521_1 to 521_n and the controller 522 are described in the above, so it is not repeated herein.

It is noted that, in the present exemplary embodiment, the switch module 62 further includes a plurality of switch units 621_1 to 621_n. One end of the switch unit 621_i is coupled to the endpoint Vin_i′, and another end of the switch unit 621_i is coupled to the endpoint Vout′. The endpoint Vin_i′ is coupled to the connection interface unit 401_i, the endpoint Vout′ is coupled to the memory control circuit unit 404, and the switch unit 621_i is configured to turn on or cut off the channel 601_i between the endpoint Vin_i′ and the endpoint Vout′, where 0<i<(n+1) and i is an integer.

In the present exemplary embodiment, the channels 501_i and 601_i are connected to the same connection interface unit 401_i. For example, if the channel 501_i is a receive channel configured to transmit signal from the endpoint Vin_i to the endpoint Vout, then the channel 601_i is a transmit channel configured to transmit signal from the endpoint Vout′ to the endpoint Vin_i′. Alternatively, if the channel 501_i is the transmit channel configured to transmit signal from the endpoint Vout to the endpoint Vin_i, then the channel 601_i is the receive channel configured to transmit signal from the endpoint Vin_i′ to the endpoint Vout′.

In the present exemplary embodiment, the switch units 521_1 to 521_n and 621_1 to 621_n are controlled by the controller 522. The controller 522 may synchronously control the switch units 521_i and 621_i, so that the channels 501_i and 601_i may be synchronously turned on or cut off. For example, in a specific time point, according to an analysis result of the signal analysis module 61, the controller 522 may synchronously control the switch units 521_1 and 621_1 to turn on the channels 501_1 and 601_1, and synchronously control the switch units 521_2 to 521_n and 621_2 to 621_n to cut off the channels 501_2 to 501_n and 601_2 to 601_n.

In one exemplary embodiment, the operation of turning on the channel 501_i (and/or the channel 601_i) may be also referred to as the operation of enabling the connection interface unit 401_i, and the operation of cutting off the channel 501_i (and/or the channel 601_i) may be also referred to as the operation of disabling the connection interface unit 401_i. The enabled connection interface unit may be used to transmit data signal, and the disabled connection interface unit cannot be used to transmit data signal. In one exemplary embodiment, whether a specific connection interface unit is disabled or not, the host system may provide power (or said power signal) to the memory storage device 10 through the specific connection interface unit. In addition, in one exemplary embodiment, if the first host system and the second host system are both coupled to the memory storage device 10, the first host system may charge the second host system via the memory storage device 10.

It is noted that, in the exemplary embodiments of FIG. 5 and FIG. 6 above, the non-power signal is analyzed and the analysis result is accordingly generated. However, in another exemplary embodiment of FIG. 5 or FIG. 6, at least one of the signal analyzers 511_1 to 511_n may analyze power signal and non-power signal of the same or different connection interface units to generate the analysis result, and the controller 522 may control the switch units 521_1 to 521_n to turn on one of the channels 501_1 to 501_n and cut off the rest according to the analysis result.

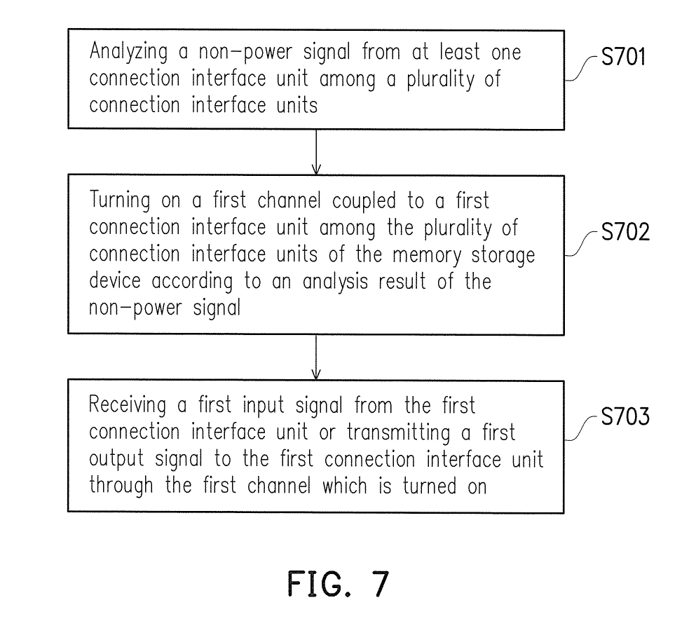

FIG. 7 is a flowchart illustrating a channel switching method according to an exemplary embodiment of the invention.

Please refer to FIG. 7, in the step S701, the non-power signal from at least one connection interface unit among a plurality of connection interface units is analyzed. In the step S702, a first channel coupled to a first connection interface unit among the plurality of connection interface units of the memory storage device is turned on according to an analysis result of the non-power signal. In the step S703, a first input signal from the first connection interface unit is received or a first output signal to the first connection interface unit is transmitted through the first channel which is turned on.

However, every steps in FIG. 7 are illustrated above, so which are not repeated herein. It is noted that, the steps depicted in FIG. 7 may be implemented as a plurality of program codes or circuits, which are not particularly limited in the invention. In addition, the method of FIG. 7 may be applied in accompany with the aforementioned exemplary embodiments, or may be applied individually, which is not limited in the present invention.

Based on the above, the channel switching device of the present invention may analyze the signal from at least one connection interface unit of the memory storage device, and the analyzed signal includes at least a non-power signal. According to an analysis result, the channel switching device may turn on a first channel coupled to a first connection interface unit of the memory storage device, to receive a first input signal from the first connection interface unit or transmit a first output signal to the first connection interface unit through the first channel which is turned on. Therefore, for the memory storage device coupled to at least one external device through a plurality of connection interface units simultaneously, a probability of mistakenly enabling or disabling a specific connection interface unit may be reduced by analyzing the non-power signal.

The previously described exemplary embodiments of the present invention have the advantages aforementioned, wherein the advantages aforementioned not required in all versions of the invention.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A channel switching device, comprising:
a signal analysis module, coupled to a plurality of connection interface units of a memory storage device;
a switch module, coupled to the signal analysis module,
wherein the signal analysis module is configured to analyze at least one non-power signal from at least one connection interface unit among the plurality of connection interface units,
wherein the switch module is configured to turn on a first channel coupled to a first connection interface unit among the plurality of connection interface units of the memory storage device according to an analysis result of the at least one non-power signal,
wherein the first channel is turned on for receiving a first input signal from the first connection interface unit or transmitting a first output signal to the first connection interface unit.

2. The channel switching device as claimed in claim 1, wherein the plurality of connection interface units comprise the first connection interface unit and a second connection interface unit, wherein the first connection interface unit is compatible to a first connection interface standard, the second connection interface unit is compatible to a second connection interface standard, and the first connection interface standard is different from the second connection interface standard.

3. The channel switching device as claimed in claim 1, wherein the analyzed signal comprises a first signal from the first connection interface unit, and the analysis result shows that a signal state of the first signal complies with a first activate condition corresponding to the first connection interface unit.

4. The channel switching device as claimed in claim 3, wherein the operation of analyzing the at least one non-power signal from the at least one connection interface unit among the plurality of connection interface units by the signal analysis module comprises:
determining whether a signal having a voltage level which exceeds a first preset voltage level is detected, determining whether a first data signal is detected, or determining whether a first idle signal is detected.

5. The channel switching device as claimed in claim 1, wherein the switch module is further configured to turn on a second channel coupled to a second connection interface unit among the plurality of connection interface units of the memory storage device before the first channel is turned on, wherein the second channel is turned on for receiving a second input signal from the second connection interface unit or transmitting a second output signal to the second connection interface unit,
wherein the switch module is further configured to cut off the second channel according to the analysis result.

6. The channel switching device as claimed in claim 3, wherein the analysis result further shows that a second signal does not exist, wherein the second signal corresponds to a second activate condition of a second connection interface unit among the plurality of connection interface units.

7. The channel switching device as claimed in claim 6, wherein the first activate condition corresponding to the first connection interface unit is different from the second activate condition corresponding to the second connection interface unit.

8. The channel switching device as claimed in claim 1, wherein the signal analysis module is further configured to analyze at least one power signal from at least one connection interface unit among the plurality of connection interface units to generate the analysis result.

9. A memory storage device, comprising:
a plurality of connection interface units, configured to couple to at least one host system;
a channel switching device, coupled to the plurality of connection interface units;
a rewritable non-volatile memory module; and
a memory control circuit unit, coupled to the channel switching device and the rewritable non-volatile memory module,
wherein the channel switching device is configured to analyze at least one non-power signal from at least one connection interface unit among the plurality of connection interface units, and turn on a first channel coupled to a first connection interface unit among the plurality of connection interface units of the memory storage device according to an analysis result of the at least one non-power signal,
wherein the memory control circuit unit is configured to receive a first input signal from the first connection interface unit or transmit a first output signal to the first connection interface unit through the first channel which is turned on.

10. The memory storage device as claimed in claim 9, wherein the plurality of connection interface units comprise the first connection interface unit and a second connection interface unit, wherein the first connection interface unit is compatible to a first connection interface standard, the second connection interface unit is compatible to a second connection interface standard, and the first connection interface standard is different from the second connection interface standard.

11. The memory storage device as claimed in claim 9, wherein the analyzed signal comprises a first signal from the first connection interface unit, and the analysis result shows that a first signal state of the first signal complies with a first activate condition corresponding to the first connection interface unit.

12. The memory storage device as claimed in claim 11, wherein the operation of analyzing the at least one non-power signal from the at least one connection interface unit among the plurality of connection interface units by the channel switching device comprises:
determining whether a signal having a voltage level which exceeds a first preset voltage level is detected, determining whether a first data signal is detected, or determining whether a first idle signal is detected.

13. The memory storage device as claimed in claim 9, wherein the channel switching device is further configured to turn on a second channel coupled to a second connection interface unit among the plurality of connection interface units of the memory storage device before the first channel is turned on,
wherein the memory control circuit unit is further configured to receive a second input signal from the second connection interface unit or transmit a second output signal to the second connection interface unit through the second channel which is turned on,
wherein the channel switching device is further configured to cut off the second channel according to the analysis result.

14. The memory storage device as claimed in claim 11, wherein the analysis result further shows that a second signal does not exist, wherein the second signal corresponds to a second activate condition of a second connection interface unit among the plurality of connection interface units.

15. The memory storage device as claimed in claim 14, wherein the first activate condition corresponding to the first connection interface unit is different from the second activate condition corresponding to the second connection interface unit.

16. The memory storage device as claimed in claim 9, wherein the channel switching device is further configured to analyze at least one power signal from at least one connection interface unit among the plurality of connection interface units to generate the analysis result.

17. A channel switching method adapted for a memory storage device having a plurality of connection interface units, the channel switching method comprising:
analyzing at least one non-power signal from at least one connection interface unit among a plurality of connection interface units;
turning on a first channel coupled to a first connection interface unit among the plurality of connection interface units of the memory storage device according to an analysis result of the at least one non-power signal; and
receiving a first input signal from the first connection interface unit or transmitting a first output signal to the first connection interface unit through the first channel which is turned on.

18. The channel switching method as claimed in claim 17, wherein the plurality of connection interface units comprise the first connection interface unit and a second connection interface unit, wherein the first connection interface unit is compatible to a first connection interface standard, the second connection interface unit is compatible to a second connection interface standard, and the first connection interface standard is different from the second connection interface standard.

19. The channel switching method as claimed in claim 17, wherein the analyzed signal comprises a first signal from the first connection interface unit, and the analysis result shows that a first signal state of the first signal complies with a first activate condition corresponding to the first connection interface unit.

20. The channel switching method as claimed in claim 19, wherein the step of analyzing the at least one non-power signal from the at least one connection interface unit among the plurality of connection interface units comprises:
determining whether a signal having a voltage level which exceeds a first preset voltage level is detected, determining whether a first data signal is detected, or determining whether a first idle signal is detected.

21. The channel switching method as claimed in claim 17, further comprising:
turning on a second channel coupled to a second connection interface unit among the plurality of connection interface units of the memory storage device before the first channel is turned on;
receiving a second input signal from the second connection interface unit or transmitting a second output signal to the second connection interface unit through the second channel which is turned on; and
cutting off the second channel according to the analysis result.

22. The channel switching method as claimed in claim 19, wherein the analysis result further shows that a second signal does not exist, wherein the second signal corresponds to a second activate condition of a second connection interface unit among the plurality of connection interface units.

23. The channel switching method as claimed in claim 22, wherein the first activate condition corresponding to the first connection interface unit is different from the second activate condition corresponding to the second connection interface unit.

24. The channel switching method as claimed in claim 17, further comprising:
analyzing at least one power signal from at least one connection interface unit among the plurality of connection interface units to generate the analysis result.
